(19) United States
(12) Patent Application Publication
(10) Pub. No.: US 2014/0308971 A1
(43) Pub. Date: Oct. 16, 2014

(54) Vehicle System for Detecting a Three-Dimensional Location of a Wireless Device

(71) Applicant: LEAR CORPORATION, Southfield, MI (US)

(72) Inventors: Thomas O'Brien, Troy, MI (US); Hilton W. Girard, III, West Bloomfield, MI (US); Jason Bauman, Huntington Woods, MI (US); Jian Ye, Troy, MI (US); Riad Ghabra, Dearborn Heights, MI (US)

(73) Assignee: Lear Corporation, Southfield, MI (US)

(21) Appl. No.: 13/863,852

(22) Filed: Apr. 16, 2013

(51) Int. Cl. H04W 4/04

(52) U.S. Cl. CPC H04W 4/046
USPC 455/456.1

(57) ABSTRACT

A vehicle system is provided with a portable device that is configured to provide a wireless signal. The vehicle system includes at least three base stations for being positioned about a vehicle within a first plane and a fourth base station for being positioned within the vehicle and vertically offset from the first plane to define a second plane with two of the at least three base stations. Each base station is configured to receive the wireless signal and to generate a message indicative of a time of flight of the wireless signal. The fourth base station is further configured to determine a three-dimensional location of the portable device based on the message generated by each base station.

### TECHNICAL FIELD

One or more embodiments relate to a vehicle system and method for determining a location of a wireless device about a vehicle in three dimensions.

### BACKGROUND

Many modern vehicles are equipped one or more transceivers for communicating with a key fob using radio signals for controlling vehicle functions, such as passive keyless entry and passive starting. With passive entry, a vehicle controller determines which door to unlock based on the location of the key fob with respect to the vehicle. Such passive keyless entry systems often include up to six low frequency (LF) antennas. Each LF antenna is mounted proximate to a vehicle door (e.g., within the handle) and communicates with the key fob to determine its location. With passive start, a vehicle controller determines whether the driver is inside the vehicle or outside the vehicle based on the fob location. Such passive start systems often include at least one antenna inside of the vehicle, and another antenna externally mounted to the vehicle, (e.g., on the roof). Thus a vehicle equipped with a passive entry/passive start (PEPS) system may have up to eight antennas.

### SUMMARY

In at least one embodiment, a vehicle system is provided with a portable device that is configured to provide a wireless signal. The vehicle system includes at least three base stations for being positioned about a vehicle within a first plane and a fourth base station for being positioned within the vehicle and vertically offset from the first plane to define a second plane with two of the at least three base stations. Each base station is configured to receive the wireless signal and to generate a message indicative of a time of flight of the wireless signal. The fourth base station is further configured to determine a three-dimensional location of the portable device based on the message generated by each base station.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 is a schematic view of a vehicle with a vehicle system for detecting a three-dimensional location of a wireless device according to one or more embodiments;

FIG. 2 is a detailed schematic view of the wireless device, a main base station and an auxiliary base station according to one embodiment;

FIG. 3 is a flow chart depicting a method for determining a three-dimensional location of the wireless device in accordance with one or more embodiments;

FIG. 4 is a top schematic view of the vehicle system of FIG. 1, illustrating a first node plane intersecting three of the base stations;

FIG. 5 is a side schematic view of the vehicle system of FIG. 1, illustrating a second node plane intersecting three of the base stations and the first node plane;

FIG. 6 depicts a first location of the wireless device relative to the first node plane; and

FIG. 7 depicts a second location of the wireless device relative to the second node plane.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components.

Therefore, specific structural and functional details disclosed herein are not to be interpreted as limiting, but merely as a representative basis for teaching one skilled in the art to variously employ the present invention.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, RAM, ROM, EPROM, EEPROM, or other suitable variants thereof) and software which co-act with one another to perform any number of the operation(s) as disclosed herein.

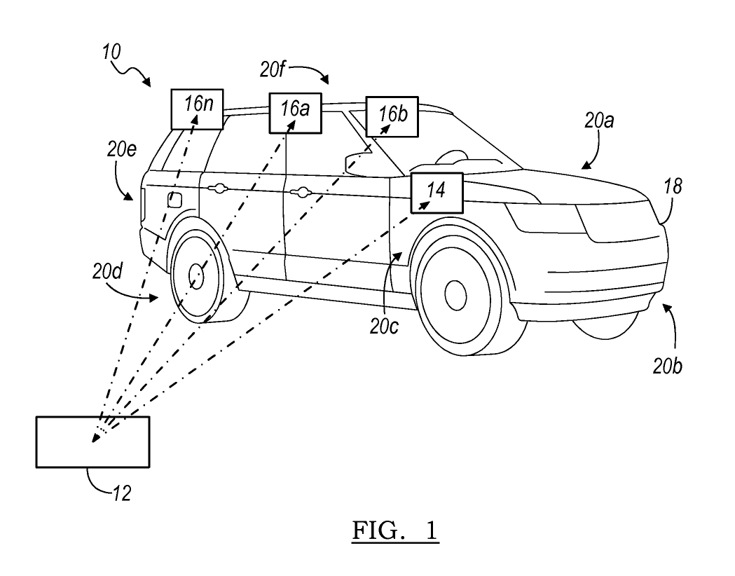

Referring to FIG. 1, a vehicle system for determining a location of a wireless device is illustrated in accordance with one or more embodiments and is generally referenced by numeral 10. The vehicle system 10 includes a portable wireless device 12 (e.g., a key fob) and at least four nodes, including a main base station 14 and at least three auxiliary base stations 16a, 16b, 16n (“16”). According to the illustrated embodiment, three of the nodes 16 are located within an upper portion of the vehicle (e.g. within a headliner). The main base station 14 (fourth node) is vertically spaced apart from the other nodes 16 and located in an intermediate portion of the vehicle (e.g. within a dashboard). The vertical spacing of the fourth node 14 relative to the other nodes 16 allows the vehicle system 10 to determine the position of the fob 12 in three dimensions.

The main base station 14, the auxiliary base stations 16, and the fob 12 engage in a series of signal exchanges with one another and utilize a time of flight (TOF) implementation to determine a distance of the fob 12 from the vehicle 18. Thereafter, the nodes 14, 16 employ trilateration to locate the actual zone 20 that the fob 12 is positioned within. The use of trilateration enables the main base station 14 to locate where the fob 12 is positioned horizontally from the vehicle. The vertical offset between the fourth node 14 and the other nodes (16a, 16b, 16n) enables the vehicle system 10 to calculate a three-dimensional (3-D) location of the fob 12 relative to multiple planes, using trilateration. Such 3-D analysis provides for a more accurate location determination, than 2-D analysis relative to a single plane. This information (e.g., which zone 20 the fob 12 is positioned within) coupled with distance information as ascertained by utilizing TOF enables the main base station 14 to locate with increased levels of accuracy the location of the fob 12 in relation to the vehicle 18.

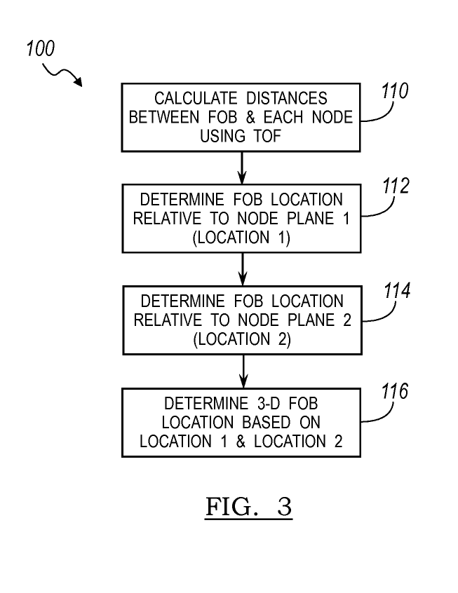

For example, the main base station 14 may determine that the fob 12 is positioned at a distance of three meters away from the vehicle 18 and that the fob 12 is positioned in the driver side zone 20a. While it is noted that the location of the fob 12 may be ascertained via the TOF and trilateration, it is recognized that the aspects noted herein with respect to locating the fob 12 may be applicable to other vehicle functions such as, but not limited to, tire pressure monitoring. While utilizing the TOF, it is recognized that the main base station 14 and the auxiliary base stations 16 may be positioned at predetermined locations in the vehicle 18 for transmitting and receiving signals to and from the fob 12. In one or more embodiments the nodes 14, 16 are located within a vehicle headliner (as shown in FIG. 1) and oriented in a generally triangular configuration (as shown in FIG. 3).

The main base station 14 generally includes additional circuitry to lock and unlock the vehicle 18 in response to command signals as provided by the fob 12. The vehicle system 10 performs a passive entry passive start (PEPS) function in which the main base station 14 unlocks the vehicle 18 in response to determining that the fob 12 is positioned in a corresponding zone 20a-20n (“20”) about the vehicle. For example, the illustrated embodiment depicts a front driver side zone 20a, a vehicle front zone 20b, a front passenger side zone 20c, a rear passenger side zone 20d, a vehicle rear zone 20e, and a rear driver side zone 20f. The zones 20 generally correspond to predetermined authorized locations about the vehicle 18 (e.g., interior to and exterior to the vehicle 18) such that if the fob 12 is detected to be in one of such zones 20, then the main base station 14 may automatically unlock the vehicle (or door) proximate to the zone 20 in which the fob 12 is detected to be within and enable the user to start the vehicle.

The vehicle system 10 utilizes remote keyless operation in addition to the PEPS function, according to one or more embodiments. For example, the main base station 14 may perform a desired operation (e.g., lock, unlock, lift gate release, etc.) with the vehicle 18 in the event the fob 12 transmits a command indicative of the desired operation while within the authorized zone 20.

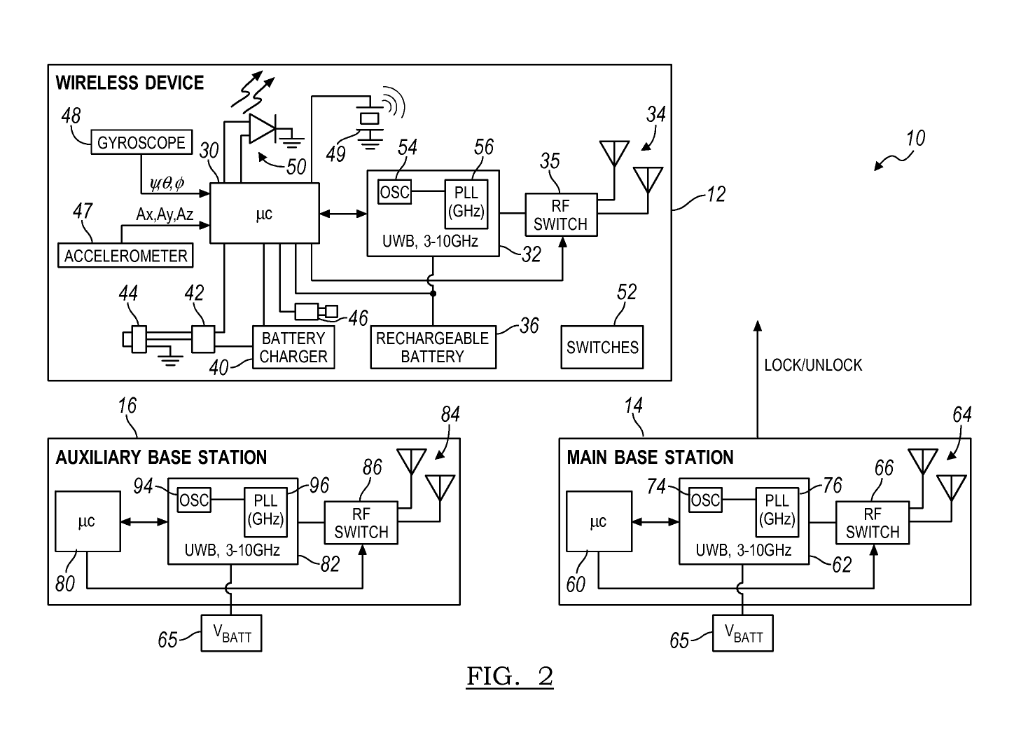

FIG. 2 depicts a detailed schematic view of the fob 12, the main base station 14, and the auxiliary base station(s) 16 in accordance with one or more embodiments. The fob 12 includes a microcontroller 30, a transmitter/receiver (“transceiver”) 32, and at least one antenna 34. The microcontroller 30 is operably coupled to the transceiver 32 and the antenna 34 for transmitting and receiving signals to/from the main base station 14 and the auxiliary base stations 16. A radio frequency (RF) switch 35 is operably coupled to the antennas 34 for coupling the same to the transceiver 32. A multiple antenna 34 implementation may provide for antenna diversity which may aid with respect to radio frequency multi-paths. The use of the RF switch 35 and multiple antennas are optional. For example, a single antenna 34 may be used for transmitting and receiving signal to and from the fob 12.

The fob 12 includes a rechargeable battery 36 that powers the microcontroller 30 and the transceiver 32 according to one or more embodiments. A battery charger circuit 40 receives power from a charger connector 42 that is operably coupled to an external power supply (not shown). The microcontroller 30 may control a first lighting indicator 44 and/or a vibrating motor 46 to provide feedback to the user that is indicative of the state of charge of the battery 36. The fob 12 may also include an accelerometer 47 and a gyroscope 48 for detecting the motion of the wireless device 12. The accelerometer 47 may provide data that is indicative of the acceleration of the fob 12 in three axis (Aₓ, A_{y}, and A_{z}). The gyroscope 48 may provide orientation data that is indicative of a yaw rate (Ψ), a pitch rate (θ), and a roll rate (φ) of the fob 12. Further, a piezo-sounder 49 and a second lighting indicator may also be operably coupled to the microcontroller 30 for providing additional feedback. A plurality of switches 52 are positioned on the wireless device 12 for transmitting commands to the vehicle 18 for initiating a number of vehicle operations (e.g., door lock and unlock, lift gate release, remote start, etc.).

The transceiver 32 is generally configured to operate at a frequency of between 3 and 10 GHz and communicate within an ultra-wide band (UWB) bandwidth of at least 500 MHz. Such high frequency communication in the UWB bandwidth enables the vehicle system 10 to determine a distance of the fob 12 with respect to the vehicle within a high degree of accuracy. The transceiver 32 generally includes an oscillator 54 and a phase locked loop (PLL) 56 for enabling the transceiver 32 to operate at the frequency of between 3 and 10 GHz.

The microcontroller 30 is operably coupled to the transceiver 32 and the antenna 34 for transmitting a wireless signal 58 to the main base station 14 and each auxiliary base station 16. The wireless signal 58 includes data such as encryption data, the acceleration data (Aₓ, A_{y}, and A_{z}), and the gyroscope data (Ψ, θ, and φ) according to one or more embodiments.

The main base station 14 generally includes a microcontroller 60, a transceiver 62, and at least one antenna 64. A power source 65 in the vehicle 18 powers the microcontroller 60 and the transceiver 62. An RF switch 66 is operably coupled to the microcontroller 60 and to the antenna 64. The RF switch 66 is operably coupled to the antennas 64 for coupling the same to the transceiver 62. A multiple antenna 64 implementation may provide for antenna diversity which may aid with respect to RF multi-paths. It is also contemplated that a single antenna 64 may be used for transmitting and receiving signal to and from the fob 12 without the need for the RF switch 66. The microcontroller 60 is operably coupled to the transceiver 62 and the antenna 64 for transmitting and receiving signals to/from the fob 12 (e.g., the wireless signal 58) and the auxiliary base station 16. The microcontroller 60 determines the position of the fob 12 based on these signals. The main base station 14 further includes circuitry (not shown) for performing locking/unlocking of vehicle doors and/or a liftgate/trunk and for performing remote start operation.

The transceiver 62 is also generally configured to operate at a frequency of between 3 and 10 GHz and communicate within an ultra-wide band (UWB) bandwidth of at least 500 MHz. Operating the transceiver 62 at an operating frequency of between 3 and 10 GHz and within the UWB bandwidth may enable the main base station 14 to determine the distance of the fob 12 with respect to the vehicle within a high degree of accuracy when it engages in communication with the fob 12. The transceiver 62 generally includes an oscillator 74 and a PLL 76 for enabling the transceiver 62 to operate at the frequency of between 3 and 10 GHz.

The auxiliary base station 16 generally includes a microcontroller 80, a transceiver 82, and at least one antenna 84. An RF switch 86 is operably coupled to the microcontroller 60 and to the antenna 64. The RF switch 86 and the multi-antenna 84 implementation are optional for the reasons noted above. The microcontroller 80 is operably coupled to the transceiver 82 and the antenna 84 for transmitting and receiving signals to/from the fob 12 (e.g. the wireless signal 58) and the main base station 14. The power source 65 in the vehicle 18 powers the microcontroller 80 and the transceiver 82.

The transceiver 82 is also generally configured to operate at a frequency of between 3 and 10 GHz and communicate within an ultra-wide band (UWB) bandwidth of at least 500 MHz. Operating the transceiver 82 at an operating frequency of between 3 and 10 GHz enables the vehicle system 10 to determine the distance of the fob 12 with respect to the vehicle within a high degree of accuracy when it engages in communication with the fob 12. The transceiver 82 generally includes an oscillator 94 and a PLL 96 for enabling the transceiver 62 to operate at the frequency of between 3 and 10 GHz. It is recognized that the second and third auxiliary base stations 16b, 16n (shown in FIG. 1) are similar to the auxiliary base station 16 as described above and include similar components and provides similar functionality. In other embodiments, the vehicle system 10 includes simple auxiliary base stations 16 that only include the antennas 84, which are controlled by the microcontroller 60 of the main base station 14.

Each auxiliary base station 16 receives the wireless signal 58 from the fob 12, and transmits a message 98 to the main base station 14 that includes information that is indicative of the time of flight of the wireless signal. The message 98 may also include the acceleration data (Aₓ, A_{y}, and A_{z}) and the gyroscope data (Ψ, θ, and φ). The main base station 14 also receives the wireless signal 58 and generates a message (not shown) that includes information that is indicative of the time of flight of the wireless signal 58 along with the acceleration and gyroscope data. The auxiliary base stations 16 may communicate wirelessly with the main base station 14, or through a wired connection. In one embodiment the auxiliary base stations 16 communicate with the main base station 14 using a local interconnect network (LIN).

The fob 12, the main base station 14, and the auxiliary base stations 16 are each arranged to transmit and receive data within the UWB bandwidth of at least 500 MHz, this aspect may place large current consumption requirements on such devices. For example, by operating in the UWB bandwidth range, such a condition yields a large frequency spectrum (e.g., both low frequencies as well as high frequencies) and a high time resolution which improves ranging accuracy. Power consumption may not be an issue for the main base station 14 and the auxiliary base station 16 since such devices are powered from the power source 65 in the vehicle. However, this may be an issue for the fob 12 since it is a portable device. Generally, portable devices are equipped with a standalone battery. In the event the standalone battery is implemented in connection with the fob 12 that transmits/receives data in the UWB bandwidth range, the battery may be depleted rather quickly. To account for this condition, the fob 12 includes the rechargeable battery 36 and the battery charger circuit 40, along with the charger connector 42 (or wireless implementation) such that the battery 36 can be recharged as needed to support the power demands used in connection with transmitting/receiving information in the UWB bandwidth range.

Existing PEPS systems (not shown) often include up to eight LF antennas that are located about the vehicle. The structure of the vehicle blocks the LF signals, therefore the antennas are mounted externally, or near windows to provide line of sight communication. Such systems often determine the location of the key fob based on a received signal strength (RSS) of a wireless signal.

The vehicle system 10 communicates at high frequency (e.g., 3-10 GHz) which allows for a reduced number of antennas as compared to existing systems. In general, the higher the operating frequency of the transceivers 32, 62, and 82; the larger the bandwidth that such transceivers 32, 62, and 82 can transmit and receive information. Such a large bandwidth (i.e., in the UWB bandwidth) may improve noise immunity and improve signal propagation. This may also improve the accuracy in determining the distance of the fob 12 since UWB bandwidth allows a more reliable signal transmission. As noted above, an operating frequency of 3-10 GHz enables the transceivers 32, 62, and 82 to transmit and receive data in the UWB range. The utilization of the UWB bandwidth for the fob 12, the main base station 14, and the auxiliary base stations 16 may provide for (i) the penetration of the transmitted signals to be received through obstacles (e.g., improved noise immunity), (ii) high ranging (or positioning) accuracy, (iii) high-speed data communications, and (iv) a low cost implementation. Due to the plurality of frequency components in the UWB spectrum, transmitted data may be received at the fob 12, the main base station 14, and the auxiliary base station 16 more reliably when compared to data that is transmitted in connection with a narrow band implementation (e.g., carrier frequency based transmission at 315 MHz, etc.). For example, UWB based signals may have both good reflection and transmission properties due to the plurality of frequency components associated therewith. Some of the frequency components may transmit through various objects while others may reflect well off of objects. These conditions may increase the reliability in the overall reception of data at the fob 12, the main base station 14, and the auxiliary base stations 16. Further, transmission in the UWB spectrum may provide for robust wireless performance against jamming. This may also provide for an anti-relay attack countermeasure and the proper resolution to measure within, for example, a few centimeters of resolution.

The implementation of UWB in the fob 12, the main base station 14, and the auxiliary base stations 16 is generally suitable for TOF applications. Although UWB based signals may have good reflection properties, the TOF calculations may become complicated if based on reflected signals. Therefore the base stations 14, 16 are mounted within the passenger compartment and near windows or the windshield (e.g., within the headliner or dashboard) to allow for generally line of sight communication with the fob 12.

The vehicle system 10 determines a distance between the fob 12 and each node (main base station 14 and auxiliary base stations 16) using TOF. The vehicle system 10 then determines a 3-D location of the fob 12, including which zone 20 (shown in FIG. 1) the fob 12 is presently located in using trilateration. Each node 14, 16 receives the wireless signal 58 from the fob 12 and generates a message having information that is indicative of the time of flight of the wireless signal 58. The main base station 14 receives the time of flight information from each node 14, 16 and engages in TOF measurements to determine a first distance (Dᵢ) between the fob 12 and the main base station 14, a second distance (D₂) between the fob 12 and the first auxiliary base station 16a, a third distance (D₃) between the fob 12 and the second auxiliary base station 16b, and a fourth distance (D₄) between the fob 12 and the third auxiliary base station 16n. At least three distance readings are needed such for each trilateration calculation. The vehicle system 10 performs multiple trilateration calculations to determine a 3-D location of the fob 12.

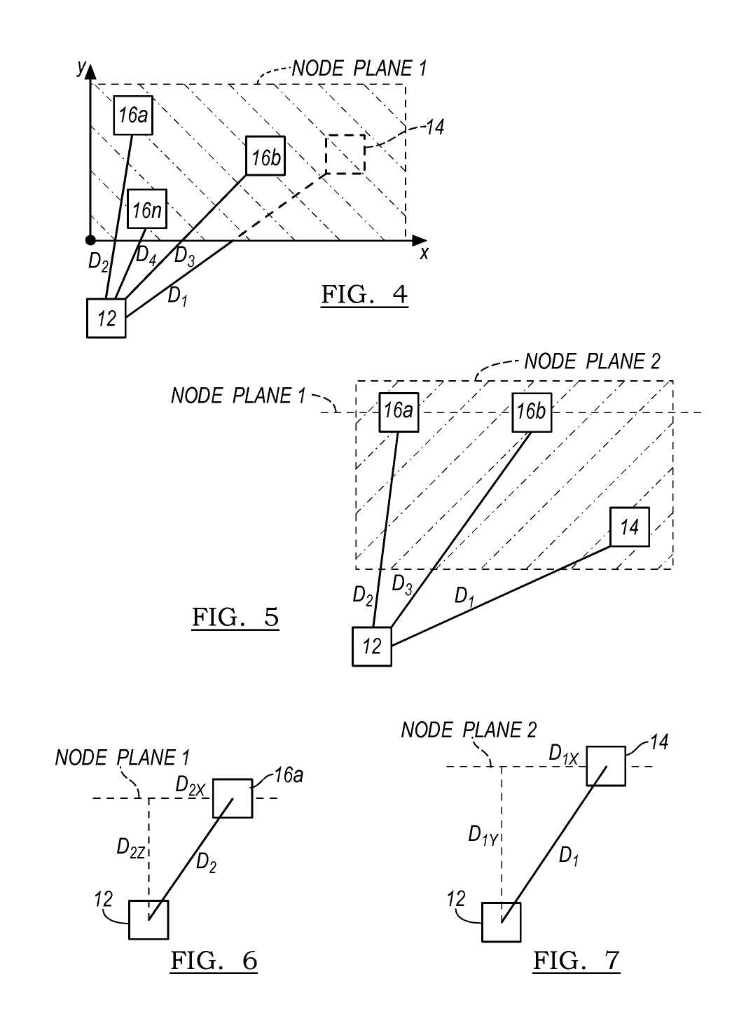

FIG. 3 is a flow chart 100 illustrating a method for determining a 3-D location of the fob 12 relative to the vehicle 18 (shown in FIG. 1), according to one or more embodiments. At operation 110, the vehicle system 10 calculates distances (D₁, D₂, D₃, D₄) between the fob 12 and the four nodes 14, 16a, 16b, and 16n, respectfully, using TOF techniques. FIG. 4 is a top view of the vehicle system 10, and illustrates three of the nodes (16a, 16b, and 16n) located in a common horizontal (XY) plane (“Node Plane 1”). The fourth node (the main base station 14) is vertically offset from Node Plane 1. As shown in FIG. 5, a second plane (“Node Plane 2”) is defined by a plane that intersects nodes 14, 16a, and 16b. Node Plane 2 also intersects Node Plane 1. Other Node Planes (not shown) may be defined by planes that intersect the main base station 14 and other combinations of the auxiliary base stations 16, such as (14, 16a, 16n) and (14, 16b, 16n).

At operation 112, the vehicle system 10 determines a location of the fob 12 relative to Node Plane 1. This fob location may be referenced as “Location 1”. FIG. 6 illustrates a simplified view of a TOF calculation with respect to the first auxiliary base station 16a of Node Plane 1. With reference to FIG. 6, the vehicle system 10 determines a distance (D₂) between the fob 12 and the node 16a using TOF. This distance D₂ is the hypotenuse of a right triangle comprising a base (D_{2X}) which represents a longitudinal displacement, and a height (D_{2Z}) which represents a vertical displacement. Similarly, the vehicle system 10 determines the distance (D₃) between the second auxiliary base station 16b and the fob 12, and the distance (D₄) between the third auxiliary base station 16n and the fob 12. The vehicle system 10 determines Location 1 of the fob 12 relative to Node Plane 1 using trilateration, based on distances D₂, D₃, and D₄.

If the fob 12 is presently located at the same vertical height as the first node plane, then the distances D₂, D₃, and D₄ would correspond to the actual horizontal distance of the fob 12 from each node 16. However, the greater the vertical offset between the fob 12 and the nodes 16, the greater the horizontal difference between the calculated distance (e.g., D₂) and the actual horizontal distance (e.g., D_{2X}). For example, in one embodiment, the vertical displacement D_{2Z} equals 24.00 inches, and D_{2X} equals 49.49 inches. The vehicle system 10 calculates D₂ to be 55.00 inches. The difference between D₂ and D_{2X} is 5.51 inches. This difference is referred to as a hypotenuse error. If the vehicle system 10 only relied on the 2-D determination of Location 1, then this hypotenuse error could prevent the vehicle system 10 from properly locating the wireless device 12 within the proper zone, or inside/outside of the vehicle. For example, if a user is sitting in the driver's seat and generally below a base station, then the vehicle system might “push” the location of the keyfob outside of the vehicle, and not allow the user to passively start the vehicle.

At operation 114, the vehicle system 10 determines a location of the fob 12 relative to Node Plane 2. This fob 12 location may be referenced as “Location 2”. FIG. 7 illustrates a simplified view of a TOF calculation with respect the main base station 14 in Node Plane 2. As shown in FIG. 5, Node Plane 2 is a plane that intersects nodes 14, 16a, and 16b. The vehicle system 10 calculates a distance (D₁) between the fob 12 and the node 14. This distance (D₁) is the hypotenuse of a right triangle comprising a base (D_{1X}) which represents a longitudinal displacement, and a height (D_{1Y}) which represents a lateral displacement. The vehicle system 10 determines Location 2 of the fob 12 relative to Node Plane 2 using trilateration, based on distances D₁, D₂, and D₃.

At operation 116, the vehicle system 10 determines a 3-D location of the fob 12 based on Location 1 and Location 2.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle system comprising:
a portable device configured to provide a wireless signal;
at least three base stations for being positioned about a vehicle within a first plane; and
a fourth base station for being positioned within the vehicle and vertically offset from the first plane to define a second plane with two of the at least three base stations, each base station being configured to receive the wireless signal and to generate a message indicative of a time of flight of the wireless signal, the fourth base station being further configured to determine a three-dimensional location of the portable device based on the message generated by each base station.

2. The vehicle system of claim 1 wherein the fourth base station is further configured to determine a distance between the portable device and each base station based on the message generated by each base station.

3. The vehicle system of claim 2 wherein the fourth base station is further configured to:
determine a first location of the portable device based on the distance between the portable device and each base station located in the first plane;
determine a second location of the portable device based on the distance between the portable device and each base station located in the second plane; and
determine the three-dimensional location of the portable device based on the first location and the second location.

4. The vehicle system of claim 3 wherein the fourth base station is further configured to determine the first location and the second location using trilateration.

5. The vehicle system of claim 1 wherein the portable device is further configured to transmit the wireless signal within a frequency between 3 GHz and 10 GHz.

6. The vehicle system of claim 1 wherein the at least three base stations are configured for being positioned proximate to a roof of the vehicle and within a headliner.

7. The vehicle system of claim 1 wherein the fourth base station is configured for being positioned within a dashboard.

8. An apparatus for determining a three-dimensional location of a portable device in relation to a vehicle, the apparatus comprising:
at least three base stations for being positioned about a vehicle to define a first plane and a main base station for being positioned about the vehicle to define a second plane with two of the at least three base stations such that the second plane intersects the first plane, each of the at least three base stations and the main base station being configured to transmit and receive a wireless signal to and from a portable device and to generate a message indicative of a distance to the portable device based on the wireless signal, the main base station being further configured to:
determine a three-dimensional location of the portable device based on the distances between the portable device and each base station within the first plane and the distances between the portable device and each base station within the second plane.

9. The apparatus of claim 8 wherein each message comprises time of flight information of the wireless signal to a corresponding base station.

10. The apparatus of claim 8 wherein the main base station is further configured to:
determine a first location of the portable device based on the distance between the portable device and each base station located in the first plane;
determine a second location of the portable device based on the distance between the portable device and each base station located in the second plane; and
determine the three-dimensional location of the portable device based on the first location and the second location.

11. The apparatus of claim 8 wherein the main base station is further configured to determine the three-dimensional location of the portable device using trilateration.

12. The apparatus of claim 8 wherein each base station and the main base station is further configured to transmit and receive the wireless signal to and from the portable device within an ultra-wide band (UWB) bandwidth.

13. The apparatus of claim 8 wherein the at least three base stations are configured for being positioned proximate to one or more vehicle windows for transmitting and receiving the wireless signal therethrough.

14. The apparatus of claim 8 wherein the main base station is configured for being positioned proximate to a windshield for transmitting and receiving the wireless signal therethrough.

15. A vehicle system comprising:
a portable device configured to transmit a wireless signal to a first base station, a second base station, and a third base station positioned within a vehicle headliner, and to transmit a wireless signal to a fourth base station positioned within a passenger compartment, each of the first base station, the second base station, the third base station and the fourth base station being configured to receive the wireless signal and to generate a message indicative of a time of flight of the wireless signal, the fourth base station being further configured to determine a three-dimensional location of the portable device based on the message generated by each base station.

16. The vehicle system of claim 15 wherein the first base station, the second base station and the third base station are each configured for being positioned in a first plane, and wherein the fourth base station is configured for being positioned vertically offset from the first plane to define a second plane with the first base station and the second base station.

17. The vehicle system of claim 16 wherein the second plane intersects the first plane.

18. The vehicle system of claim 16 wherein the fourth base station is further configured to:
determine a distance between the portable device and each base station based on the message generated by each base station;
determine a first location of the portable device based on the distance between the portable device and each base station located in the first plane;
determine a second location of the portable device based on the distance between the portable device and each base station located in the second plane; and
determine the three-dimensional location of the portable device based on the first location and the second location.

19. The vehicle system of claim 18 wherein the fourth base station is further configured to define a third plane with the second base station and the third base station.

20. The vehicle system of claim 19 wherein the fourth base station is further configured to:
determine a third location of the portable device based on the distance between the portable device and each base station located in the third plane; and
determine the three-dimensional location of the portable device based on the first location, the second location and the third location.
